(19) United States
(12) Patent Application Publication
(10) Pub. No.: US 2020/0245819 A1
(43) Pub. Date: Aug. 6, 2020

(54) FASTENING DEVICE FOR A HANDLE

(71) Applicant: BAUMGARTEN HANDLE SYSTEMS KG, Neunkirchen (DE)

(72) Inventors: Michael Besche, Betzdorf (DE); Stefan Klaus, Wilnsdorf (DE)

(21) Appl. No.: 16/776,763

(22) Filed: Jan. 30, 2020

(30) Foreign Application Priority Data
Feb. 1, 2019 (DE) 10 2019 102 574.5

(51) Int. Cl. A47J 45/07

(52) U.S. Cl. CPC A47J 45/07

(57) ABSTRACT

A device for fastening a handle to cookware or bakeware having a support piece protruding outward from the cookware or bakeware wall. The handle is detachably snapped onto the support piece, and has a frontal recess, and a spring element retained in the recess acting on a latching element of the. When the handle is snapped onto the support piece, an actuation element activates the spring element. The support piece has a fork element clamped in the recess of the handle at the surface parallel to its base and is supported on a support surface in an operating position.

### CROSS-REFERENCE TO RELATED APPLICATIONS

This application claims priority to German Patent Application No. DE 10 2019 102 574.5 filed Feb. 1, 2019. The contents of this application are hereby incorporated by reference as if set forth in its entirety herein.

The disclosure relates to a device for fastening a handle to cookware or bakeware according to the preamble of claim 1.

Such designs are commonly known from the state of the art. Generic devices comprise a support piece which is disposed on the cookware or bakeware and is fastened to the cookware via welds or screws, for example. Owing to the fact that the handle comprises a recess having a shape corresponding to the support piece, the handle can be slid onto the support piece and be latched or locked there. In this context, it is known that an actuation element can be provided on the handle in order to produce and/or release a latch connection. However, an extremely precise production is required for generic devices in order to guarantee a wiggle-free fit of the parts in operating position. This precise fit, however, can encumber using generic devices, in particular snapping on and releasing the handle.

From DE 199 40 970 B4 a generic device for fastening a handle to cookware or bakeware is known. This known device comprises a handle which can be snapped onto a support piece disposed on the cookware. In order to guarantee a one-handed usage of the device and a wiggle-free fit of the handle on the support piece, it is proposed that the handle comprises a recess whose geometric shape essentially coincides with the cross section of the support piece so that the legs of the support piece interact with the recess of the handle in operating position. Due to the inclined position of the contact surfaces of the support piece and/or the recess in conjunction with a spring element integrated in the handle, a wiggle-free fit can be guaranteed even when the parts have larger production tolerances. Moreover it is described that the handle can be removed from the support piece fastened at the cookware relatively easily by moving the spring element of the generic device into the unlocking position of the handle.

The documents mentioned above describe the object as being able to use the device more easily with one hand, with a secure and wiggle-free fit of the handle on the support piece still being guaranteed. This is not or only insufficiently attained by the described solution.

While the generic device enables a secure and wiggle-free fit of the handle on the support piece, the handle becomes loose due to the loads during use. Therefore a wiggle-free fit of the handle on the support piece cannot be sufficiently ensured when loads change.

Starting from this state of the art, it is the object of disclosure at hand to propose a new device for fastening a handle to cookware or bakeware in which an ergonomic and simple usage of the device is possible with one hand while still ensuring a secure, long-lasting and wiggle-free connection between the handle and the support piece under dynamic and/or cyclic load.

This object is attained by the teachings of independent claim 1.

Advantageous embodiments of the disclosure are the subject matter of the dependent claims.

The device according to the disclosure for fastening a handle to cookware or bakeware is based on the fundamental idea that the support piece comprises a window-like recess in its base and a fork element is fastened in the recess of the handle at the surface parallel to the base in operating position. In order to be able to produce a secure, long-lasting and durable connection without clearance between the support piece and the handle, it is intended from sides of the disclosure to produce the fork element from a resilient material. Such a resilient fork element is supported on the abutment surfaces in operating position and locks the system in such a manner due to the resilient characteristics of the fork element that a wiggling of the handle can be precluded. Moreover, snapping the curved end of the fork element into the window-like recess can be made easier by a resilient fork element and the feel can be improved, in particular when loads change—e.g., when emptying or filling the cookware or bakeware—, thereby increasing comfort of usage.

For easily and ergonomically snapping the fork element into the window-like recess, the fork element has at least one curved section and one flat section according to a preferred embodiment, the fork element engaging into the window-like recess with its curved end. Since the fork element is guided due to its geometry when being snapped into the window-like recess, the handle can be easily snapped onto the support piece disposed on the cookware and bakeware. The design of the fork element according to the disclosure ensures that the fork element does not become wedged when being snapped into the window-like recess. Moreover, it has also been seen as substantial to the disclosure that the fork element is fastened in the recess of the handle by clamping and not by a screw connection as known from the state of the art. This allows attaining a wiggle-free centered fit during changing loads and consistent use, since a screw connection which could become loose is not required for fastening the fork element. Moreover, by forgoing the screw connection at the fork element, mounting the fork element is particularly easy and spontaneous.

The design of the support piece is generally arbitrary. With regard to a mostly clearance-free fit of the support piece, it is advantageous if the support piece has an essentially U-shaped cross section having legs jutting out approximately vertical in operating position and if the recess of the handle has a corresponding cross section. At least one leg of the support piece and/or at least one surface of the recess of the handle, the surface interacting with a leg of the support piece when the parts are in use, is set at such an angle that the leg or the legs of the support piece enclose(s) an obtuse angle with its base. Alternatively thereto, the wall of the recess corresponding to the leg can enclose an obtuse angle with the base of the support piece in operating position.

In order to enable easily snapping the fork element into the window-like recess of the handle, it is particularly advantageous if the fork element is essentially curved like an S at the curved section. Owing to this S-shaped curve of the fork element at the curved section, an attachment protrusion is formed on this curved section and guarantees a secure and durable support while simultaneously having a smallest possible abutment surface.

In order to be able to guarantee that the fit is as secure and wiggle-free as possible, it is particularly advantageous if the fork element is supported by the flat section on the one hand and by the attachment protrusion on the other hand on the support piece in operating position. This enables evenly distributing the forces acting on the device in operating position—e.g., caused by completely filled cookware or bakeware—within the device via the fork element so that a wiggle-free fit can be ensured even during heavy loads.

It has proven to be advantageous that the attachment protrusion of the fork element comes into contact with an essentially linear abutment surface at the support piece. Owing to the linear abutment surface and the thus resulting low space requirement of the attachment protrusion, a particularly simple snapping and locking of the handle in the cookware or bakeware is enabled and a force is introduced to the fork element in a defined manner so that the fork element can be designed according to specification in relation to the size and weight of the cookware or bakeware.

In order to be able to introduce the arising forces to the fork element in a defined and simple manner, it is intended according to a preferred embodiment that the linear abutment surface of the abutment protrusion is perpendicular to the longitudinal extension of the fork element.

For fixating the fork element and stabilizing the device in operating position, it is particularly advantageous if the flat section of the fork element in operating position rests on a rest surface formed by the base of the support piece. In the scope of the disclosure, the base refers to the section of the support piece forming the upper side of the support piece in operating position. The base, for example, is defined by the upper base of the trapeze in the transverse extension if the support piece has a trapezoidal cross section. According to the disclosure, the rest surface for the flat section of the fork element extends parallel to the upper side of the base from the window-like recess toward the actuation element in operating position. Owing to this embodiment, it is ensured that the flat end of the fork element comes to rest at the abutment surface as soon as the fork element engages in the window-like recess with its curved end, and the abutment surface of the curved end of the fork element comes into contact with the support piece. This embodiment advantageously guarantees a durable wiggle-free fit of the handle at the cookware and bakeware.

In order to achieve a particularly sturdy connection between the support piece and the handle in operating position, it is intended according to a preferred embodiment that the legs of the support piece essentially articulate with the surfaces of the recess of the handle parallel to the legs in operating position.

In which manner the actuation element is connected to the latching element is generally arbitrary. However, it has proven to be advantageous if the actuation element can be snapped onto the latching element. In contrast to a non-detachable connection or a one-piece design of the latching element and the actuation element, this two-piece design of the actuation element and the latching element makes it possible to easily and effortlessly exchange the actuation element. If the actuation element has been damaged through heat, for example, it becomes a problem for multiple reasons as exchanging the actuation element is only possible by to dismantling the handle into its individual pieces and/or components. By employing the solution according to the disclosure, the actuation element can be easily removed on its own and be exchanged for an undamaged actuation element.

In order to be able to easily realize a positioning of the latching element in operating position and when disassembled, a spring element is intended according to a preferred embodiment against whose spring force the actuation element is displaceably retained on the handle parallel to the longitudinal handle extension. Advantageously, the latching element is positioned such when displacing the actuation element that a retaining flange disposed at the latching element engages under the front rim of the base of the support piece in operating position and releases the front rim of the base of the support piece when disassembled. This easily makes it possible for the retaining flange to secure the connection between the support piece and the handle in operating position and to release the front rim of the base when dismantled so that the handle can be removed from the support piece.

In order to realize a smooth displacement of the actuation element and the latching element and to achieve a low space requirement of the latching element while simultaneously providing a sufficiently sturdy connection between the handle and the support piece in operating position, it has proven to be advantageous if the retaining flange of the latching element is beveled at the front side.

It has further proven to be advantageous if a helical spring is disposed as a spring element in the recess of the handle. A helical spring can be disposed in the handle requiring particularly little space by disposing it such that the helical spring is supported on the backside of the latching element facing away from the front surface on the one hand and at a surface parallel thereto at the end of the recess of the handle on the other hand.

Of which material the support piece consists and in which manner the support piece has been produced is generally arbitrary. In order to realize a long service life, comfortable feel and an inexpensive production, it is particularly advantageous if the support piece is produced by cast molding.

An embodiment of the device according to the disclosure is schematically illustrated in the drawings and is explained in the following using examples.

FIG. 1 illustrates in a longitudinal cut a support piece disposed on a cookware or bakeware wall and a handle when disassembled;

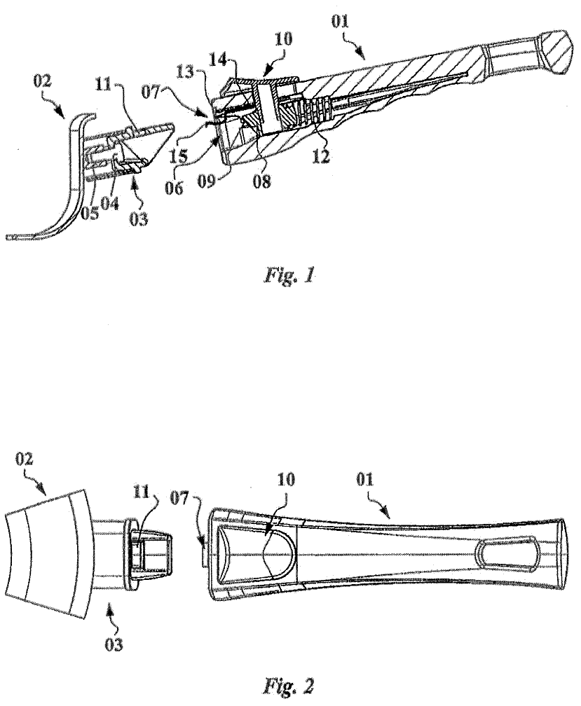

FIG. 2 illustrates in a top view the support piece and the handle according to FIG. 1;

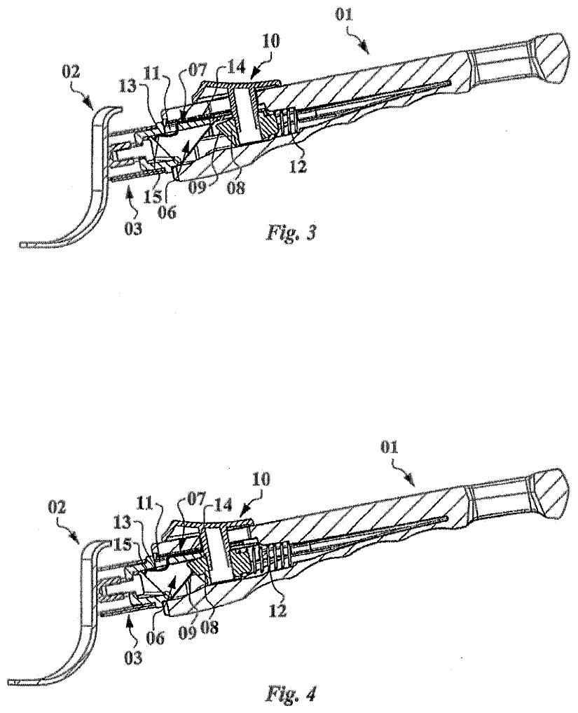

FIG. 3 illustrates in a longitudinal cut the support piece and the handle in operating position having a released front rim of the base of the support piece;

FIG. 4 illustrates in a longitudinal cut the support piece and the handle in operating position having the retaining flange engaging under the front rim of the base of the support piece.

In the embodiments according to FIG. 1 to FIG. 4, support piece 03 is fastened to a slug 05 by means of a screw 04, slug 05 being disposed at the wall of cookware 02. In recess 06 of handle 01, a spring element 12 is disposed and a fork element 07 is fastened by clamps. In the illustrated embodiment, actuation element 10 is snapped onto latching element 08 comprising a retaining flange 09. Fork element 07 has a flat section 14 and a curved section 13. Curved section 13 is essentially shaped like an S so that an attachment protrusion 15 is formed which comes into contact with support piece 03 in operating position. Support piece 03 is formed having a snapping bevel and has a window-like recess 11 in its base, curved section 13 of fork element 07 being snapped onto window-like recess 11 in operating position.

FIG. 2 illustrates cookware 02, support piece 03 and handle 01 in a top view according to FIG. 1. In this top view, window-like recess 11 onto which curved end 13 of fork element 07 is snapped for realizing the operating position is illustrated. Actuation element 10 is also illustrated which can be displaced on handle 01 parallel to the longitudinal handle extension.

FIG. 3 and FIG. 4 illustrate in a longitudinal cut the cookware having handle 01 snapped onto support piece 03. Fork element 07 is fastened by clamps in recess 06 of handle 01. Attachment protrusion 15 of essentially S-shaped section 13 of fork element 07 engages into window-like recess 11 of the base of support piece 03 and abuts against an essentially linear abutment surface at support piece 03. Flat section 14 of fork element 07 is supported on a support surface which is formed by the base and extends parallel to the upper side of the base from window-like recess 11 toward actuation element 10. Owing to this disposition of resilient fork element 07 in operating position, fork element 07 is braced and provides the required sturdiness and a wiggle-free fit. In the area of recess 06 disposed in handle 01 and at a distance from cookware 02, a spring element 12 is disposed against whose spring force actuation element 10 can be displaced which is connected by being snapped onto latching element 08. In FIG. 3, latching element 08 is positioned such that retaining flange 09 disposed at latching element 08 and having a beveled front surface releases the front rim of the base of support piece 03. In FIG. 4, in contrast, the connection between support piece 03 and handle 01 is secure since retaining flange 09 disposed at latching element 08 engages under the front rim of the base of support piece 03.

1. A device for fastening a handle to cookware or bakeware having a support piece protruding outward from the cookware or bakeware wall and the handle which can be detachably snapped onto the support piece, the handle having a frontal recess configured to snap the handle onto the support piece, and a spring element being retained in the recess of the handle, the spring element acting on a latching element of the handle, which latches onto the support piece, when the handle is snapped onto the support piece, an actuation element being provided on the handle, the spring element being activated by means of the actuation element,
wherein
the support piece has a window-like recess in its base and a fork element is clamped in the recess of the handle at the surface parallel to the base in operating position, the fork element being made of resilient material, and the resilient fork element being supported on a support surface in operating position.

2. The device according to claim 1, wherein the fork element has at least one curved section and one flat section, the fork element engaging into the window-like recess with its curved section.

3. The device according to claim 1, wherein the support piece has an essentially U-shaped cross section having legs jutting out approximately vertical in operating position and the recess of the handle having a corresponding cross-sectional shape, at least one leg of the support piece and/or at least one surface of the recess of the handle interacting with a leg of the support piece when the parts are in use being set at an angle such that the leg or the legs of the support piece enclose(s) an obtuse angle with its base and/or the wall of the recess corresponding to the leg encloses an obtuse angle with the base of the support piece in operating position.

4. The device according to claim 1, wherein the fork element is curved essentially like an S at the curved section, an attachment protrusion being formed.

5. The device according to claim 1, wherein the fork element is supported on the support piece by the flat section on the one hand or by the attachment protrusion on the other hand in operating position.

6. The device according to claim 1, wherein the attachment protrusion abuts against the support piece with an essentially linear abutment surface.

7. The device according to claim 1, wherein the linear abutment surface of the attachment protrusion is aligned perpendicular to the longitudinal extension of the fork element.

8. The device according to claim 1, wherein the flat section of the fork element in operating position rests on a rest surface formed by the base, the rest surface extending parallel to the upper side of the base from the window-like recess toward the actuation element.

9. The device according to claim 1, wherein the support piece and/or the recess of the handle has a trapezoidal cross section.

10. The device according to claim 1, wherein the legs of the support piece in operating position essentially articulate with the surfaces of the recess which are parallel thereto.

11. The device according to claim 1, wherein the actuation element is latched onto the latching element.

12. The device according to claim 1, wherein the actuation element is retained on the handle in a displaceable manner parallel to the longitudinal handle extension against the spring force of the spring element, the actuation element positioning the latching element such that a retaining flange engages under the front rim of the base of the support piece in operating position and releases the front rim of the base of the support piece when removed.

13. The device according to claim 1, wherein the retaining flange of the latching element is beveled at the front surface.

14. The device according to claim 1, wherein a helical spring is disposed as a spring element, the helical spring being supported on the backside of the latching element on the one hand and at a surface parallel thereto at the end of the recess of the handle on the other hand.

15. The device according to claim 1, wherein the support piece is produced by cast molding.
